(19) United States
(12) Patent Application Publication
(10) Pub. No.: US 2016/0314615 A1
(43) Pub. Date: Oct. 27, 2016

(54) GRAPHIC PROCESSING DEVICE AND METHOD FOR PROCESSING GRAPHIC IMAGES

(71) Applicant: NEXELL CO., LTD., Seongnam-si (KR)

(72) Inventor: Sung Su KIM, Seongnam-si (KR)

(21) Appl. No.: 15/198,707

(22) Filed: Jun. 30, 2016

Related U.S. Application Data
(63) Continuation of application No. PCT/KR2014/000567, filed on Jan. 20, 2014.

(30) Foreign Application Priority Data
Jan. 20, 2014 (KR) 10-2014-0006804

(51) Int. Cl. G06T 15/80; G06T 1/20

(52) U.S. Cl. CPC G06T 15/80; G06T 1/20

(57) ABSTRACT

Provided is a graphic processing device and method for a graphic processing. The graphic processing device includes: a scan converter configured to calculate raster data and generate a first shading request signal requesting shading for pixels corresponding to a polygon based on the raster data; a fragment skipper configured to group the pixels corresponding to the first shading request signal into at least one pixel group, to select at least one of pixels included each pixel group as a shading pixel, and to generate a second shading signal requesting shading for the shading pixel in each pixel group; a shader configured to perform shading for the shading pixel in each pixel group to generate a value of the shading pixel in each pixel group based on the second shading request signal; and a fragment filter configured to generate an image by calculating values of the pixels corresponding to the polygon based on the values of the shading pixel in each pixel group.

### CROSS-REFERENCE TO RELATED APPLICATIONS

The present application is a continuation of International Application No. PCT/KR2014/000567, filed on Jan. 20, 2014, which claims priority from Korean Patent Application No. 10-2014-0006804, filed on Jan. 20, 2014, each of which is hereby incorporated by reference in its entirety.

### BACKGROUND

1. Field

The present invention relates to a graphic processing technique, and more particularly, to a graphic processing technique specialized in high-resolution graphics.

2. Discussion of the Background

Recently, with rapid developments of various technologies, the sizes of display devices have been enlarged. For graphic processing corresponding to the resolution of a large display device, operation quantity increases and thus, a high-specification graphic processing device is preferred.

However, in the high-specification graphic processing device, since the size of the display device is large and the price and the production costs of the display device are increased, the specification of the graphic processing device needs to be lowered through a change of an existing graphic pipeline in certain circumstances.

### SUMMARY

Exemplary embodiments of the present invention provide a graphic processing device and method for processing shading by removing a part of a fragment.

Further, other technical objects desired to be achieved by one or more exemplary embodiments of the present invention are not limited to the objects discussed herein, and other technical objects not described herein will be apparent to those skilled in the art from the present disclosure.

According to an aspect of the present invention, there is provided a graphic processing device including: a scan converter configured to calculate raster data and generate a first shading request signal requesting shading for pixels corresponding to a polygon based on the raster data; a fragment skipper configured to group the pixels corresponding to the first shading request signal into at least one pixel group, to select at least one of pixels included each pixel group as a shading pixel, and to generate a second shading signal requesting shading for the shading pixel in each pixel group; a shader configured to perform shading for the shading pixel in each pixel group to generate a value of the shading pixel in each pixel group based on the second shading request signal; and a fragment filter configured to generate an image by calculating values of the pixels corresponding to the polygon based on the values of the shading pixel in each pixel group.

The fragment skipper may select at least one of the pixels included in each pixel group as the shading pixel depending on a relative position of the pixels in each pixel group when pixels corresponding to the first shading request signal is set to at least one pixel group based on the position.

The fragment skipper may select one of the pixels included in each pixel group as the shading pixel depending on a relative position of the pixels in the corresponding pixel group when pixels corresponding to a block of 2×2 are set to a single pixel group based on positions of the pixels corresponding to the first shading request signal.

The fragment filter may calculate an average value of the shading pixels adjacent to a filtering pixel as the value of the filtering pixel.

According to another aspect of the present invention, there is provided a graphic processing method in a graphing processing device including: calculating raster data by rasterizing input data; selecting at least one of pixels included in each pixel group as a shading pixel by grouping pixels corresponding to a polygon into at least one pixel group based on the raster data; performing shading for the shading pixel in each pixel group to generate a value of the shading pixel; and generating an image by calculating values of the pixels corresponding to the polygon based on the value of the shading pixel in each pixel group.

The shading pixel, which is a pixel satisfying a predetermined condition among the pixels corresponding to the polygon, may be selected depending on the raster data. The shading pixel may be at least one of the pixels included in each pixel group and may be determined depending on a relative position of each pixel in the corresponding pixel group, in a case where the pixels corresponding to the polygon are set as at least one pixel group based on the position.

The selecting of the shading pixel depending on the raster data may be selecting one of the pixels included in each pixel group as the shading pixel depending on a relative position of each pixel in the corresponding pixel group, in a case where the pixels corresponding to a block of 2×2 are set to a single pixel group based on the positions of the pixels corresponding to the polygon.

The generating of the image by calculating a value of a filtering pixel, which is a pixel other than the shading pixel among the pixels corresponding to the polygon, with reference to the values of the adjacent shading pixels. An average value of the shading pixels adjacent to the filtering pixel may be determined as the value of the filtering pixel. The adjacent shading pixels may be one or more shading pixels in a pixel group adjacent to the pixel group in which the filtering pixel is included and one or more shading pixels in the pixel group in which the filtering pixel is included. According to an exemplary embodiment, the adjacent shading pixel may be a shading pixel that is adjacent to the filtering pixel. According to an exemplary embodiment, the adjacent shading pixel may be a shading pixel of which a corner contacts a corner of the filtering pixel.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating a graphic processing device according to an exemplary embodiment of the present invention;

FIG. 2 is a diagram exemplifying pixels depending on a polygon of input data and raster data in a graphic processing device according to an exemplary embodiment of the present invention;

FIG. 3 is a diagram illustrating shading pixels which are selected by a graphic processing device according to an exemplary embodiment of the present invention;

FIG. 4 is a diagram illustrating a temporary image of the shading pixels which are shaded by a graphic processing device according to an exemplary embodiment of the present invention;

FIG. 5 is a diagram illustrating an image generated by applying values of filtering pixels by a graphic processing device according to an exemplary embodiment of the present invention; and

FIG. 6 is a flowchart illustrating a process of performing graphic processing by a graphic processing device according to an exemplary embodiment of the present invention.

### DETAILED DESCRIPTION OF THE ILLUSTRATED EMBODIMENTS

The following description illustrates principles of the present invention and various exemplary embodiments. Therefore, those skilled in the art may implement the principles of the invention and create various devices within a concept and a scope of the invention even though not explicitly described or illustrated in the specification. Further, all conditional terms and exemplary embodiments enumerated in the present specification have a clear intention only for the purpose of understanding the concept of the invention in principle, and shall not be understood that the conditional terms and exemplary embodiments are limited to the specially enumerated exemplary embodiments and states.

It shall be understood that all detailed descriptions enumerating a specific exemplary embodiment, as well as the principle, the aspect, and the exemplary embodiments of the present invention are intended to include a structural and functional equivalent thereof. Further, it is understood that such equivalents include all elements which are invented so as to perform the same function as the currently disclosed equivalents and equivalents which will be developed in the future regardless of the structure.

Accordingly, it should be understood that all of a flowchart, a status transitional view, and a pseudo code are substantially represented in a computer readable medium and indicate various processes executed by a computer or a processor regardless of whether a computer or a processor is apparently illustrated.

Functions of various elements illustrated in the drawings including a functional block which is represented by a processor or a similar concept may be provided by using not only exclusive hardware but also hardware which may execute software with regard to appropriate software. If the function is provided by the processor, the function may be provided by a single exclusive processor, a single shared processor or a plurality of individual processors and some of them may be shared.

The above objects, features, and advantages will be more obvious from the detailed description with reference to the accompanying drawings, and the technical spirit of the present invention may be easily carried out by those skilled in the art. In the following description, a detailed explanation of known related functions and constitutions may be omitted so as to avoid unnecessarily obscuring the subject matter of the present invention.

Hereinafter, exemplary embodiments of the present invention will be described in more detail with reference to the accompanying drawings.

The present invention may be variously modified and have various exemplary embodiments, so that specific embodiments will be illustrated in the drawings and described in the detailed description. However, this does not limit the present invention within specific exemplary embodiments, and it should be understood that the present invention covers all the modifications, equivalents and replacements within the idea and technical scope of the present invention.

Further, in this specification, when it is mentioned that one constitute element transmits a signal to the other constitute element, the one constitute element is directly connected with the other constitute element to transmit the signal, but unless otherwise specifically reversely described, it should be understood that the one constitute element transmits the signal to the other constitute element via another element therebetween.

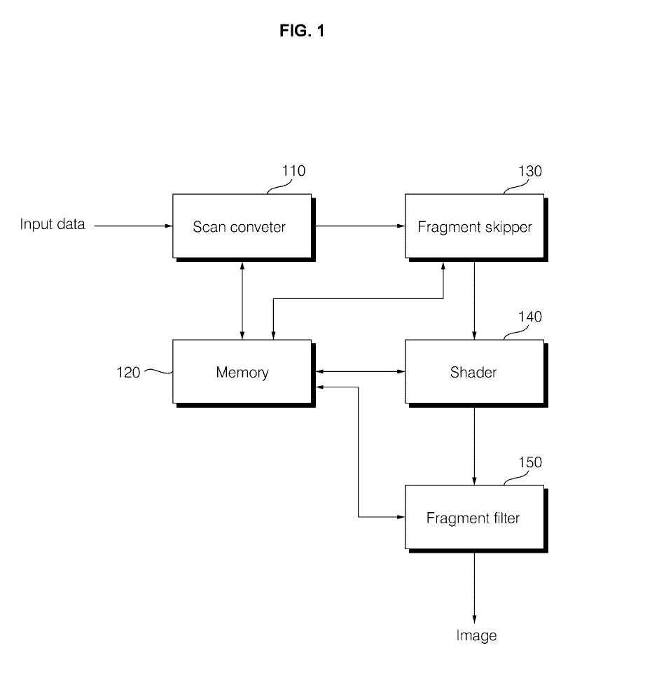

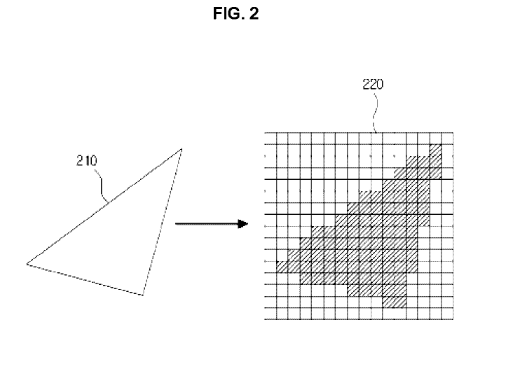

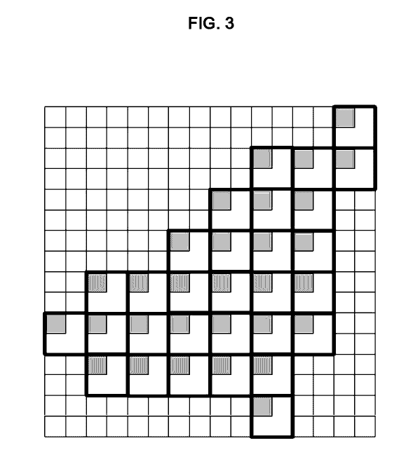

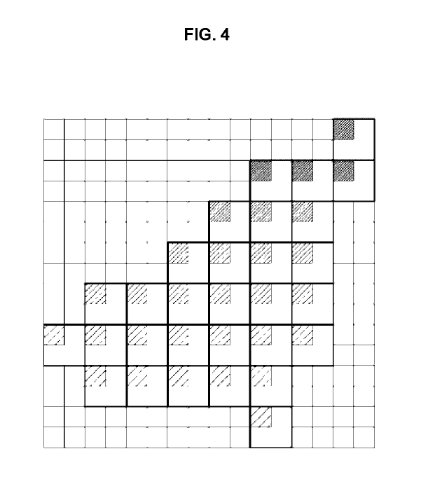

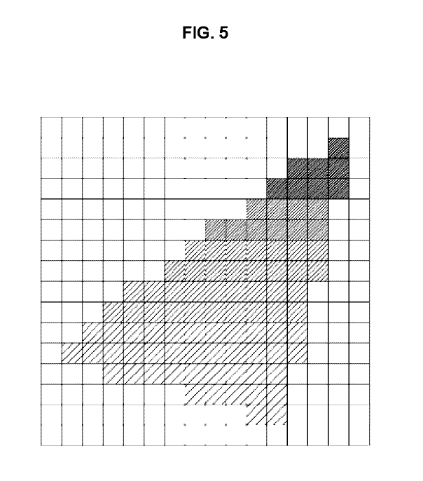

FIG. 1 is a block diagram illustrating a graphic processing device according to an exemplary embodiment of the present invention, FIG. 2 is a diagram exemplifying pixels depending on a polygon of input data and raster data in a graphic processing device according to an exemplary embodiment of the present invention, FIG. 3 is a diagram illustrating shading pixels which are selected by a graphic processing device according to an exemplary embodiment of the present invention, FIG. 4 is a diagram illustrating a temporary image of the shading pixels which are shaded by a graphic processing device according to an exemplary embodiment of the present invention, and FIG. 5 is a diagram illustrating an image generated by applying values of filtering pixels by a graphic processing device according to an exemplary embodiment of the present invention. Hereinafter, the graphic processing device may refer to a device that is installed or connected to a known computing device such as a personal computer and a terminal and performs graphic processing to generate an image.

Referring to FIG. 1, a graphic processing device 100 may include a scan converter 110, a memory 120, a fragment skipper 130, a shader 140, and a fragment filter 150. When such constituent elements are implemented in an actual application, if necessary, two or more constituent elements are united to one constituent element, or one constituent element is subdivided into two or more constituent elements.

The scan converter 110 receives input data including a graphic model from a source, e.g., a computing device, which may be connected with the graphic processing device 100 through a wired or wireless connection. The input data represents at least one of 2D and 3D image data. In this case, the graphic model may be a model that is formed by one or more polygons by a known method in a computer graphic field. The scan converter 110 generates raster data representing pixels corresponding to each polygon by rasterizing the model of the input data. The raster data may include values that represent the image including at least one polygon corresponding to a plurality of pixels.

For example, as illustrated in FIG. 2, the scan converter 110 may generate the raster data representing pixels (gray pixels of the reference numeral 220) corresponding to the polygon when the polygon 210 is projected onto a specific projection surface. The scan converter 110 stores the raster data in the memory 120 and transmits a shading request signal for requesting shading for each pixel corresponding to the polygon. In this case, the scan converter 110 may be hardware in which one or more processors and digital elements (gates) are implemented by a known method or other methods.

The memory 120 may be a storage medium that stores data used in the graphic processing. The memory 120 may be a volatile memory 120. In an example, the memory may be a DRAM, an SRAM, a flash memory, etc., but aspects are not limited as such.

The fragment skipper 130 selects pixels that satisfy a predetermined condition among pixels corresponding to the shading request signal received from the scan converter 110 (hereinafter, the selected pixels are referred to as shading pixels) and transmits the shading request signal for the selected pixels to the shader 140. The pixels corresponding to a polygon may be divided into a plurality of pixel groups based on at least one of the shape of the polygon, the determined boundary of the polygon, value distribution characteristics of the pixels corresponding to the polygon. For example, the values of the pixels corresponding to the polygon may be changed radically based on the position of the pixel in the polygon shape or may be similar regardless of the position of the pixel in the polygon shape. Further, the size of each pixel group may be determined based on a predetermined filtering level.

For example, as illustrated in FIG. 3, the fragment skipper 130 divides the selected pixels into pixel groups of a unit of 2×2 based on the projection surface by referring to the raster data stored in the memory 120 and selects a pixel corresponding to a predetermined relative position among each pixel group. More specifically, the fragment skipper 130 may select the pixel group constituted by four pixels indicated by a thick line in FIG. 3 and select a pixel of which the relative position is the upper-left portion among each pixel group, for example. However, the relative position is not limited as such. The fragment skipper 130 transmits the shading request signal for the selected pixel to the shader 140. In this case, the fragment skipper 130 may be implemented as one or more digital elements.

The shader 140 may perform the shading for the pixel corresponding to the shading request signal which is received from the fragment skipper 130. For example, as illustrated in FIG. 4, the shader 140 generates an image by performing the shading that sets a value for the pixel selected in the fragment skipper 130 and stores the corresponding image in the memory 120. In this case, the image generated by the shader 140 is referred to as a temporary image. At this stage, values of filtering pixels may not be determined

The fragment filer 150 calculates values of pixels (hereinafter, referred to as filtering pixels) corresponding to the polygon other than the shaded pixels (the shading pixels) in the temporary image. The fragment filer 150 may calculate an average of the values of certain number of closest shading pixels with respect to each filtering pixel and apply the average to the value of the corresponding filtering pixel.

For example, for the filtering pixel at the upper right side of the pixel group, the fragment filter 150 may calculate an average of values of the shading pixels of the corresponding pixel group and the shading pixel of the pixel group adjacent to the right side of the corresponding pixel group as the value of the corresponding filtering pixel. Further, for the filtering pixel at the upper right side of the pixel group, the fragment filter 150 may calculate an average of values of the shading pixel of the corresponding pixel group and the shading pixel of the pixel group adjacent to the right side of the corresponding pixel group as the value of the corresponding filtering pixel. Further, the filtering pixel at the lower right side of the pixel group may calculate an average of values of the shading pixels of the corresponding pixel group and the shading pixel of the pixel group adjacent to the lower right side of the corresponding pixel group as the value of the corresponding filtering pixel. In addition, the value of the filtering pixel may be calculated by various methods.

For example, the adjacent shading pixels may be one or more shading pixels in a pixel group adjacent to the pixel group in which the filtering pixel is included and one or more shading pixels in the pixel group in which the filtering pixel is included. According to an exemplary embodiment, the adjacent shading pixel may be a shading pixel that is adjacent to the filtering pixel. According to an exemplary embodiment, the adjacent shading pixel may be a shading pixel of which a corner contacts a corner of the filtering pixel.

The fragment filter 150 calculates values of the filtering pixels and generates the image as illustrated in FIG. 5 by applying the corresponding value to each filtering pixel of the temporary image stored in the memory 120. The fragment filter 150 may transmit the image to the computing device connected with the graphic processing device 100.

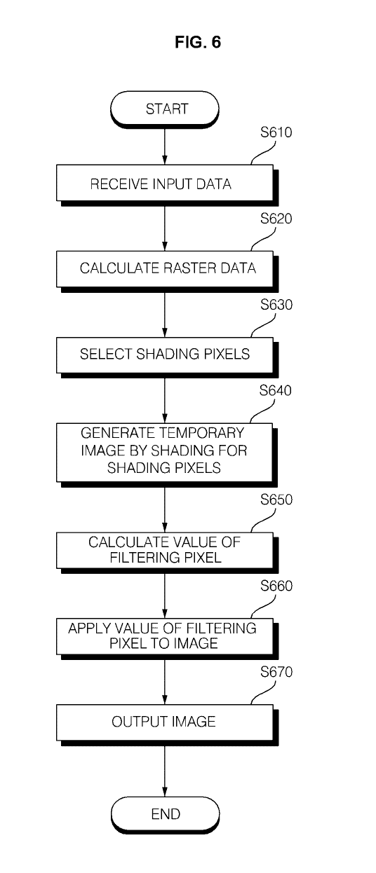

FIG. 6 is a flowchart illustrating a process of performing a graphic processing by a graphic processing device according to an exemplary embodiment of the present invention. Hereinafter, each operation of the process is collectively called a process performed by the respective functional or operational parts provided in the graphic processing device illustrated above or a similar graphic processing device. Reference numerals of FIG. 1 will be used in describing the process, but the graphic processing device configuration is not limited to that illustrated in FIG. 1.

Referring to FIG. 6, the scan converter 110 receives input data from a source, e.g., a computing device connected with the graphic processing device 100 (S610).

The scan converter 110 generates raster data by rasterizing the input data (S620). The generated raster data is stored in the memory 120.

The fragment skipper 130 selects a shading pixel that satisfies a predetermined condition by referring to the raster data (S630). For example, the fragment skipper 130 may classify the pixels corresponding to the polygon as a pixel group based on the position of each pixel by referring to the raster data and select the shading pixel based on the relative position of each pixel among the pixels in each pixel group. One or more shading pixels may be determined in each pixel group, and at least some or all of the remaining pixels in the pixel group may be determined as filtering pixels.

The shader 140 generates the temporary image by performing the shading for the shading pixels (S640). The shader 140 may generate the shaded temporary image only for the shading pixels.

The fragment filter 150 calculates the value of the filtering pixels (S650). For example, the fragment filer 150 may calculate an average value of the shading pixels adjacent to a filtering pixel as the value of the filtering pixel. The average value calculation and the determination of the value of the filtering pixel may be performed with respect to each filtering pixel.

The fragment filer 150 generates the image by setting the value of each filtering pixel of the temporary image as the corresponding value calculated in the operation S650 (S660).

The fragment filter 150 may output the image generated in the operation S660 to the computing device connected with the graphic processing device 100 (S670).

The graphic processing device may reduce the number of times of performing the shading with high operational complexity so as not to perform the shading with respect to all pixels corresponding to the polygon depending on the raster data. As a result, the graphic processing device may provide a configuration including the shader with lower specification. Therefore, as the size of the hardware configuring the shader is reduced, the high-resolution image can be rendered without enlarging the size of the corresponding graphic processing device. Moreover, the power consumption through the operation of the graphic processing can be reduced.

Exemplary embodiments of the present invention has been described with reference to the drawings. Various exemplary embodiments other than the aforementioned the exemplary embodiments are also covered by the appended claims. It is understood to those skilled in the art that the present invention may be implemented as a modified form without departing from the spirit of the present invention. Therefore, the disclosed exemplary embodiments do not limit the scope of the present invention. According to one or more exemplary embodiments of the present invention, since the number of times of performing the shading having high operational complexity is reduced so as not to perform the shading with respect to all pixels corresponding to a polygon according to the raster data, the processing load of the graphic processing for generating the high-resolution image can be reduced and the number of shader chips used in the shading process for generating the high-resolution image can be reduced.

While the exemplary embodiments of the present invention have been illustrated and described above, the present invention is not limited to the aforementioned specific exemplary embodiments, various modifications may be made by a person with ordinary skill in the art to which the present invention pertains without departing from the subject matters of the present invention.

What is claimed is:

1. A graphic processing device, comprising:
a scan converter configured to calculate raster data and generate a first shading request signal requesting shading for pixels corresponding to a polygon based on the raster data;
a fragment skipper configured to group the pixels corresponding to the first shading request signal into at least one pixel group, to select at least one of pixels included each pixel group as a shading pixel, and to generate a second shading signal requesting shading for the shading pixel in each pixel group;
a shader configured to perform shading for the shading pixel in each pixel group to generate a value of the shading pixel in each pixel group based on the second shading request signal; and
a fragment filter configured to generate an image by calculating values of the pixels corresponding to the polygon based on the value of the shading pixel in each pixel group.

2. The graphic processing device of claim 1, wherein the fragment skipper selects one of the pixels included in each pixel group as the shading pixel depending on a relative position of the pixels in each pixel group.

3. The graphic processing device of claim 1, wherein each pixel group is set as a block having a pixel size of 2×2.

4. The graphic processing device of claim 1, wherein the fragment filter calculates a value of a filtering pixel, which is a pixel other than the shading pixel among the pixels corresponding to the polygon, by averaging values of shading pixels adjacent to the filtering pixel.

5. The graphic processing device of claim 1, wherein the fragment filter transmits the image to a connected computing device.

6. The graphic processing device of claim 1, further comprising:
a memory configured to store the raster data and a temporary image generated by performing the shading for the shading pixel.

7. A graphic processing method in a graphing processing device, comprising:
calculating raster data by rasterizing input data;
selecting at least one of pixels included in each pixel group as a shading pixel by grouping pixels corresponding to a polygon into at least one pixel group based on the raster data;
performing shading for the shading pixel in each pixel group to generate a value of the shading pixel; and
generating an image by calculating values of the pixels corresponding to the polygon based on the value of the shading pixel in each pixel group.

8. The graphic processing method of claim 7, wherein the shading pixel is selected by one of the pixels included in each pixel group based on a relative position of pixels in each pixel group.

9. The graphic processing method of claim 7, wherein the pixel group is set as a block having a pixel size of 2×2.

10. The graphic processing method of claim 7, wherein in the generating of the image, a value of a filtering pixel, which is a pixel other than the shading pixel among the pixels corresponding to the polygon, is calculated by averaging values of shading pixels adjacent to the filtering pixel.

11. The graphic processing method of claim 7, further comprising:
transmitting the image to a connected computing device.
